(19) United States
(12) Patent Application Publication
(10) Pub. No.: US 2007/0074607 A1
(43) Pub. Date: Apr. 5, 2007

(54) Ratchet wrench having a pivotal body

(76) Inventor: Robert J. Balls, Hyde Park, UT (US)

Correspondence Address: Robert J. Balls;445 East 85 South, PO Box 3, Hyde Park, UT, 84318, US

(21) Appl. No.: 11/540,559

(22) Filed: Oct. 2, 2006

Related U.S. Application Data
(60) Provisional application No. 60/722,765, filed on Sep. 30, 2005.

(51) Int. Cl. B25B 13/46; B25B 23/16

(52) U.S. Cl. 81/62; 81/177.8; 81/177.9

(57) ABSTRACT

The present invention relates to a ratchet wrench having a pivotal body, which generally includes a head portion, a body, a pivotal ratchet member, and a handle. The head portion has a mouth wherein one jaw is defined with a notch therein to help disengage the mouth of the wrench when rotating the wrench opposite the notched jaw. The pivotal ratchet member is releasable allowing the handle to freely rotate unless engaged.

### BACKGROUND OF THE INVENTION

The present invention relates generally to a wrench, and more particularly to ratchet wrench having a pivotal body. The ratchet wrench includes a head portion containing a notched jaw, a wrench body, and a handle containing a pivotal member.

Particularly the invention relates to a wrench usable in limited access areas. Common wrenches have limited application when accessing nuts or bolts located deep within a structure or crevice because the common wrench handle bumps into its surroundings to provide only limited rotation. The wrench of the present invention can be used in a first configuration where the force on the wrench handle is applied directly to the wrench body to tighten or loosen nuts and bolts associated with the wrench head. Upon termination of the first rotation, due to the wrench handle abutting a neighboring structure, the wrench can be used in a second configuration achieved by a pivotal member located within the wrench body allowing the wrench handle to rotate back to its original position independent of the wrench head. Once the wrench is secured in the second configuration, a second force on the wrench handle is applied directly to the wrench body to continue rotating the nut or bolt.

The head portion of the ratchet wrench contains a mouth with a notched section removed from one of the mouth's jaws. The notched jaw allows the mouth of the wrench to easily disengage from the nut or bolt when rotating the wrench head in the direction opposite the notched jaw. Once the mouth is disengaged from the nut or bolt, the wrench can resume its first orientation, re-engage the nut or bolt and begin the rotating process again.

A variety of wrenches exist with a pivotal head. For example, U.S. Pat. No. 1,109,032 issued to M. C. Bersted, U.S. Pat. No. 1,178,287 issued to N. Anderson, and U.S. Pat. No. 928,375 all provide wrenches with adjustable heads. The operator must determine and set the angle of the wrench head relative to the wrench body before engaging a nut or bolt. In order to change the angle, the operator must remove the wrench from the nut or bolt. The mechanism attached to the head, which allows the head to rotate, makes the head portion of the wrench bulky and limits the amount of torque the wrench is capable of withstanding. The present invention allows the operator to adjust the angle between the wrench head and wrench handle without removing the mouth of the wrench from the nut or bolt. Furthermore, the wrench of the present invention, due to the location of the pivotal member, allows for a smaller head portion to access tight spaces and strengthens the wrench allowing for greater torque.

U.S. Pat. No. 6,886,429 illustrates a wrench with a pivotal head that rotates in a direction perpendicular to the rotation of the nut or bolt. Again, the mechanism attached to the head, which allows the head to rotate, makes the head portion of the wrench bulky and limits the amount of torque the wrench is capable of withstanding.

U.S. Pat. No. 1,080,121 discloses a wrench with an adjustable handle, which rotates in a direction perpendicular to the rotation of the nut or bolt, unlike the present invention, which rotates in the same direction as the nut or bolt. The object of U.S. Pat. No. 1,080,121 is to provide a handle that may be turned or adjusted at right angles to the tool to impart a cranking motion to the tool. In addition to providing a cranking motion, an object of the present invention is to maximize rotation distance with a pivotal handle that rotates in the same direction as the rotation of a nut or bolt.

The ratchet wrench of the present invention is unique in that it maximizes the rotational distance the user can rotate a nut or bolt without removing and reattaching the wrench to a nut or bolt. Additionally, the wrench is easily released from the nut or bolt due to the notched jaw within the mouth of the wrench.

Another advantage of the present invention is that the ratchet wrench has a small head portion allowing for access to nuts and bolts located within restrictive areas. The applicability of the wrench is improved by placing the pivotal member further back on the body of the wrench instead of adjacent to the wrench's head portion. When the pivotal mechanism is placed at the wrench head, he head portion becomes bigger and cannot be used in tight spaces.

Another aspect of the present invention is that it can withstand more torque than other adjustable ratchet wrenches. By placing the pivotal mechanism away from the wrench head and further back along the wrench body allows the wrench to withstand more torque, which in turn allows the user to apply more pressure to a nut or bolt.

### BRIEF SUMMARY OF THE INVENTION

The primary objective of the present invention is to provide a ratchet wrench with a pivotal body; wherein the pivotal member selectively rotates to provide a spectrum of angles between the wrench handle and the wrench body allowing the wrench to be effective in hard-to-reach areas.

The objectives of the present invention are accomplished by a ratchet wrench having a pivotal body, which generally includes a head portion, a body, a pivotal ratchet member, and a handle. The head portion has a mouth wherein one jaw is defined with a notch therein to help disengage the mouth of the wrench when rotating the wrench opposite the direction of the notched jaw. The pivotal ratchet member is releasable allowing the handle to freely rotate unless engaged.

Unless otherwise defined, all technical and scientific terms used herein have the same meaning as commonly understood by one of ordinary skill in the art to which this invention pertains. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

Other features and advantages of the invention will be apparent from the following detailed description, drawings, and from the claims.

### BRIEF DESCRIPTION OF THE DRAWINGS

FIG. 1 is a perspective view of the ratchet wrench;

FIG. 2 is a partial side view of the reversible wrench showing the head of the wrench containing a notched jaw;

FIG. 3 is cut away side view a pivotal member;

FIG. 4 is top view of a disk, which attaches to a rod extending from the bottom of the disk through the wrench handle.

### DETAILED DESCRIPTION OF THE INVENTION

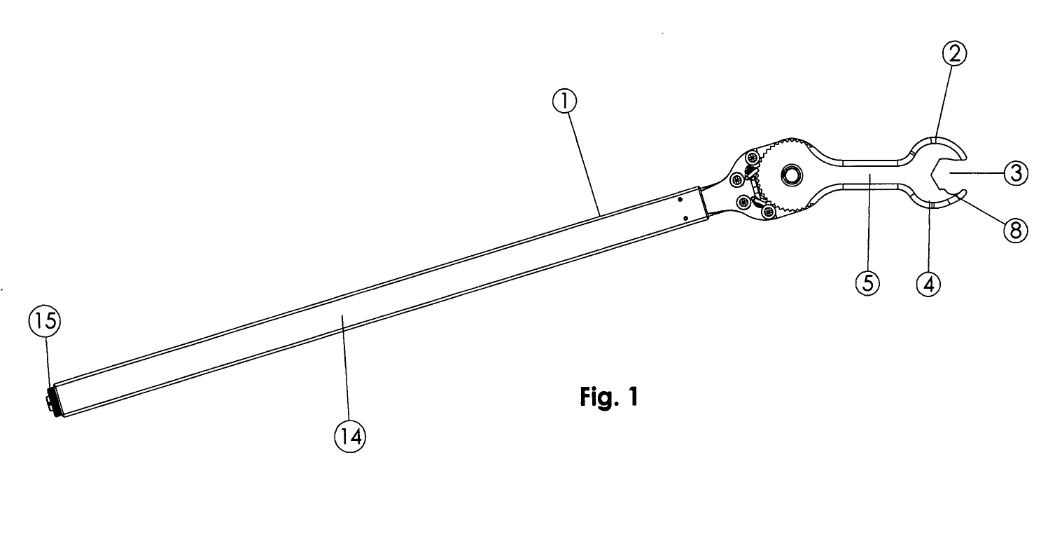

Referring more particularly to the drawings, FIG. 1 designates a ratchet wrench 1 with a pivotal body 6. Wherein the ratchet wrench is provided with a head portion 2 containing a mouth 3 from which a notched section 8 is removed from the bottom jaw 4. The head portion 2 is attached to a wrench body 5, which extends between the head portion 2 and a pivotal member 6. The pivotal member 6, when not engaged, freely rotates laterally relative to the head portion 2 and wrench body 5. Attached to and extending from the pivotal member 6 is a handle 14.

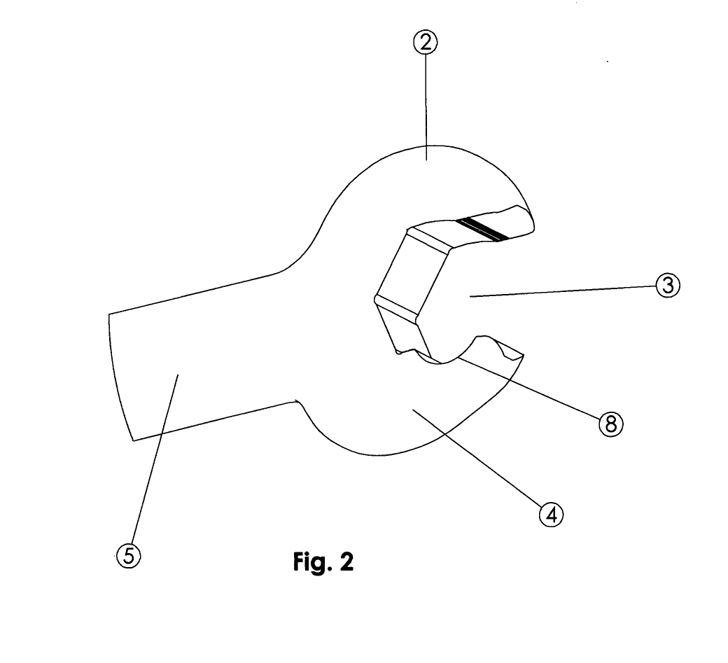

FIG. 2. illustrates the head portion 2 of the ratchet wrench 1 wherein the jaw 4 of the mouth 3 contains a notch 8. Although notch 8 in FIG. 2 is radially shaped, the notch is effective in all shapes including but not limited to square, rectangular, triangular, hexagonal, octagonal, and combinations thereof.

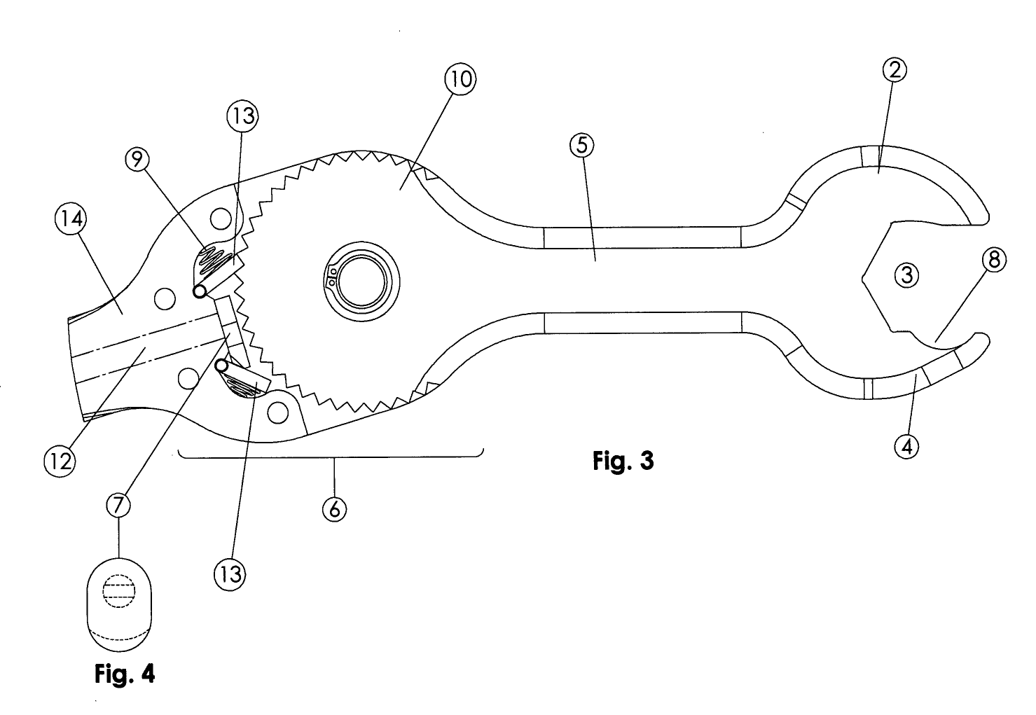

The mechanics of the pivotal member 6 can take a variety of different forms. FIG. 3. shows one pivotal means. The posterior of the wrench body 5 is radially shaped 10 having teeth 11 protruding from the outer perimeter thereof. The teeth 11 are selectively engaged with dogs 13 to restrict rotation of the pivotal member 6. Likewise dogs 13 can be selectively released to resume rotation of pivotal member 6. Dogs 13 are attached to the anterior end of handle 14. Springs 9 are placed to generate a continual force against dogs 13 such that when unrestricted, dogs 13 will engage teeth 11 of radially shaped posterior end 10 of the wrench body 5. Dogs 13 are selectively engaged allowing free rotation in one direction while prohibiting rotation in the opposite direction. An oblong disk 7 is placed between and perpendicular to dogs 13 and attached to a rod 12, which extends through handle 14; extending from the rear of handle 14 is a means 15 for rotating rod 12 to selectively release the pivotal member 6. Turning rod 12 causes the oblong disk 7 to rotate, which allows one of dogs 13 to release and engage in teeth 11, while restricting the opposite dog 13 and preventing it from engaging teeth 11. Thereby allowing a user to selectively engage and disengage the wrench by merely adjusting the posterior end of rod 12.

Although FIG. 3. shows two dogs 13 placed opposite of each other and working in tandem, the present invention also encompasses a pivotal means as shown in FIG. 3. where only one dog 13 is used. Notch 8 is included in jaw 4 of head portion 2 so that the mouth 3 can be easily detached from a nut. The notched jaw 4 is placed on the nut opposite the direction of force intended by the wrench user. After the user completes a rotation, the mouth must be disengaged from the nut and reattached preceding another rotation. Notch 8 is located such that following a completed rotation, the user does not have to remove the mouth from the nut for disengagement. Instead, the wrench mouth will rotate freely around the nut in the direction opposite of notch 8. Therefore, when only one dog 13 is used, it is preferable to place dog 13 on the same side of the wrench as the notched jaw 4.

A variety of pivotal means containing a ratchet mechanism are known in the art. For example, U.S. Pat. No. 928,375, U.S. Pat. No. 1,109,032, U.S. Pat. No. 1,178,287, U.S. Pat. No. 1,019,825, U.S. Pat. No. 6,311,583, U.S. Pat. No. 5,784,934, U.S. Pat. No. 4,274,311, U.S. Pat. No. 4,254,675, U.S. Pat. No. 4,967,624, U.S. Pat. No. 5,761,972, U.S. Pat. No. 5,957,008, U.S. Pat. No. 6,314,839, and U.S. Pat. No. 6,805,028, all disclose a ratchet mechanism and are incorporated herein by reference.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference. The mere mentioning of the publications and patent applications does not necessarily constitute an admission that they are prior art to the instant application.

Although the foregoing invention has been described in some detail by way of illustration and example for purposes of clarity of understanding, it will be obvious that certain changes and modifications may be practiced within the scope of the appended claims.

1. A ratchet wrench comprising:
a. a head portion comprising a mouth;
b. a pivotal member;
c. a body that extends between said head portion and said pivotal member;
d. a means to selectively engage or disengage said pivotal member to allow or prevent rotation; and
e. a handle extending from said pivotal member.

2. The ratchet wrench of claim 1 further comprising a notch in a jaw of said mouth to allow rotation in one direction around a bolt or nut without disengaging said mouth from the bolt or nut.

3. The ratchet wrench of claim 1 wherein the means to selectively engage or disengage said pivotal member to allow or prevent rotation comprises a ratchet mechanism.

4. The ratchet wrench of claim 3 wherein said ratchet mechanism comprises at least one dog positioned to selectively engage teeth of a notched radius to prevent rotation of the pivotal member.

5. The ratchet wrench of claim 2 wherein the means to selectively engage or disengage said pivotal member to allow or prevent rotation comprises a ratchet mechanism.

6. The ratchet wrench of claim 5 wherein said ratchet mechanism comprises at least one dog positioned to selectively engage teeth of a notched radius to prevent rotation of the pivotal member.

7. A ratchet wrench comprising
(a) a head portion comprising a mouth;
(b) a pivotal member, which selectively rotates laterally in the same direction as a nut or bolt to which the ratched wrench is attached;
(c) a body that extends between said head portion and said pivotal member
(d) a means to selectively engage or disengage said pivotal member to allow or prevent rotation and;
(e) a handle extending from said pivotal member

8. The ratchet wrench of claim 3 further comprising a notch in a jaw of said mouth to allow rotation in one direction around a bolt or nut without disengaging said mouth from the bolt or nut.

9. The ratchet wrench of claim 7 wherein the means to selectively engage or disengage said pivotal member to allow or prevent rotation comprises a ratchet mechanism.

10. The ratchet wrench of claim 9 wherein said ratchet mechanism comprises at least one dog positioned to selectively engage teeth of a notched radius to prevent rotation of the pivotal member.

11. The ratchet wrench of claim 8 wherein the means to selectively engage or disengage said pivotal member to allow or prevent rotation comprises a ratchet mechanism.

12. The ratchet wrench of claim 11 wherein said ratchet mechanism comprises at least one dog positioned to selectively engage teeth of a notched radius to prevent rotation of the pivotal member.

13. A ratchet wrench comprising
(a) a head portion comprising a mouth with a notch in a jaw of said mouth to allow rotation in one direction around a bolt or nut without disengaging said mouth from the bolt or nut;
(b) a pivotal member, which selectively rotates laterally in the same direction as a nut or bolt to which the ratched wrench is attached;
(c) a body that extends between said head portion and said pivotal member
(d) a means to selectively engage or disengage said pivotal member to allow or prevent rotation comprising a ratchet mechanism wherein the ratchet mechanism has at least one dog positioned to selectively engage teeth of a notched radius to prevent rotation of the pivotal member; and
(e) a handle extending from said pivotal member

14. The ratchet wrench of claim 13 wherein the means to selectively engage or disengage said pivotal member to allow or prevent rotation further comprises a switch extending from the rear of the handle.
